(19) United States
(12) Patent Application Publication
(10) Pub. No.: US 2021/0099818 A1
(43) Pub. Date: Apr. 1, 2021

(54) SYSTEM AND METHOD FOR EVALUATING NOISE CANCELLING CAPABILITY

(71) Applicant: Compal Electronics, Inc., Taipei City (TW)

(72) Inventors: Yi-Ching Chen, Taipei City (TW); Ching-Yu Chen, Taipei City (TW); Yun-Chiu Ching, Taipei City (TW)

(21) Appl. No.: 16/687,461

(22) Filed: Nov. 18, 2019

(30) Foreign Application Priority Data
Sep. 26, 2019 (TW) 108134895

(51) Int. Cl. H04R 29/00; G10K 11/178; H04R 3/00

(52) U.S. Cl. CPC H04R 29/00; G10K 2210/504; H04R 3/002; G10K 11/178

(57) ABSTRACT

A system and a method for evaluating noise cancelling capability are provided, and the system and method are configured to evaluate a noise cancelling capability of an external device. The system includes a mixer, a player, a recorder and a comparator. The mixer receives and mixes a target audio file and a noise audio file and outputs a mix audio file. The player is connected to the mixer for receiving the mix audio file. The player outputs a first audio signal to the external device. The external device cancels the noise of the first audio signal and outputs a second audio signal. The recorder receives the second audio signal and outputs a noise-cancelled audio file. The comparator is connected to the recorder for receiving the noise-cancelled audio file. The comparator compares the noise-cancelled audio file and the target audio file and outputs an evaluation report according to a comparing result.

### CROSS-REFERENCE TO RELATED APPLICATION

This application claims priority to Taiwan Patent Application No. 108134895, filed on Sep. 26, 2019, the entire content of which is incorporated herein by reference for all purposes.

### FIELD OF THE DISCLOSURE

The present disclosure relates to a system and a method for evaluating noise cancelling capability, and more particularly to a system and a method for evaluating noise cancelling capability, which is utilized to evaluate the noise cancelling capability of an external device.

### BACKGROUND OF THE DISCLOSURE

With the gradually popularization of the voice devices (e.g. headphones, mobile phones, hearing aids, audiophones, etc.), users have the opportunity to use the voice devices in various situations. However, the user experience may be poor due to the noise in the ambient environment. For example, if the user uses a mobile phone (or a headphone) to call in a noisy restaurant, the noise in the ambient environment is included to the microphone of mobile phone together with the speaking voice of the user. Accordingly, the listener on the other side of the call cannot clearly hear the speaking voice of the user. In addition, for the user needing the hearing assistance from hearing aids (or audiophones), the user may fail to hear the conversation or the target sound source due to the interference from the ambient noise.

Hence, there are a lots of voice devices, which are claimed to have noise cancelling capability, on the market. However, even if the user wants to verify the noise cancelling capability of the voice devices, the noise cancelling capability can only be tested and evaluated by professional testing instruments or acoustic laboratories. The process of delivering the voice device to the acoustic laboratories or the place having professional testing instrument often takes too much time and cost. Consequently, considering the time and cost of verifying the noise cancelling capability, consumers can only rely on personal hearing and production manual while choosing the device with noise cancelling capability. Consumers are unable to compare the noise cancelling performance of various products according to objective quantified data immediately. Moreover, the user can only experience the noise cancelling performance of the device under the current ambient noise, and the user cannot predict the noise cancelling performance of the device under other noisy environments (e.g., restaurants, road sides and airports).

Therefore, there is a need of providing a system and a method for evaluating noise cancelling capability in order to overcome the above drawbacks.

### SUMMARY OF THE DISCLOSURE

An object of the present disclosure provides a system and a method for evaluating noise cancelling capability. The system and the method for evaluating noise cancelling capability allow the user to conveniently and quickly evaluate the noise cancelling capability of an external device. Further, a quantified evaluation report is provided according to the evaluation result. Therefore, the user is allowed to understand the performance of the external device objectively and compares the noise cancelling capability of various external devices.

Another object of the present disclosure provides a system and a method for evaluating noise cancelling capability. The system and method are able to simulate and evaluate the noise cancelling capability of an external device under various ambient noises, which is not limited to the noise of the current surrounding of the user. It is helpful for the user to fully understand the performance of the external device.

In accordance with an aspect of the present disclosure, there is provided a system for evaluating noise cancelling capability, and the system is configured to evaluate a noise cancelling capability of an external device. The system for evaluating noise cancelling capability includes a mixer, a player, a recorder and a comparator. The mixer receives and mixes a target audio file and a noise audio file and outputs a mix audio file. The player is connected to the mixer for receiving the mix audio file. The player outputs a first audio signal to the external device. The external device cancels the noise of the first audio signal and outputs a second audio signal. The recorder receives the second audio signal and outputs a noise-cancelled audio file. The comparator is connected to the recorder for receiving the noise-cancelled audio file. The comparator compares the noise-cancelled audio file and the target audio file and outputs an evaluation report according to a comparing result.

In accordance with an aspect of the present disclosure, there is further provided a method for evaluating noise cancelling capability, and the method is configured to evaluate a noise cancelling capability of an external device. The method for evaluating noise cancelling capability includes the following steps: (a) mixing a target audio file and a noise audio file and generating a mixer audio file by a mixer; (b) generating a first audio file according to the mix audio file by a player; (c) cancelling the noise of the first audio signal and generating a second audio file by the external device; (d) generating a noise-cancelled audio file according to the second audio file by a recorder; and (e) comparing the noise-cancelled audio file and the target audio file and generating an evaluation report according to a comparing result by a comparator.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 and FIG. 2 are schematic block diagrams illustrating a system for evaluating noise cancelling capability and an external device according to an embodiment of the present disclosure; and

FIG. 3 is a flowchart illustrating a method for evaluating noise cancelling capability according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

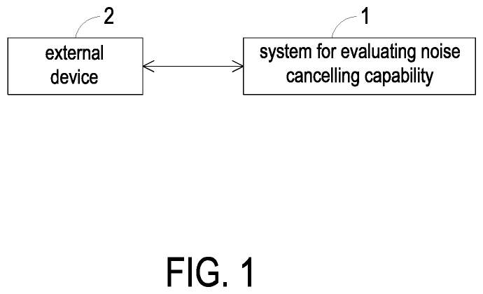

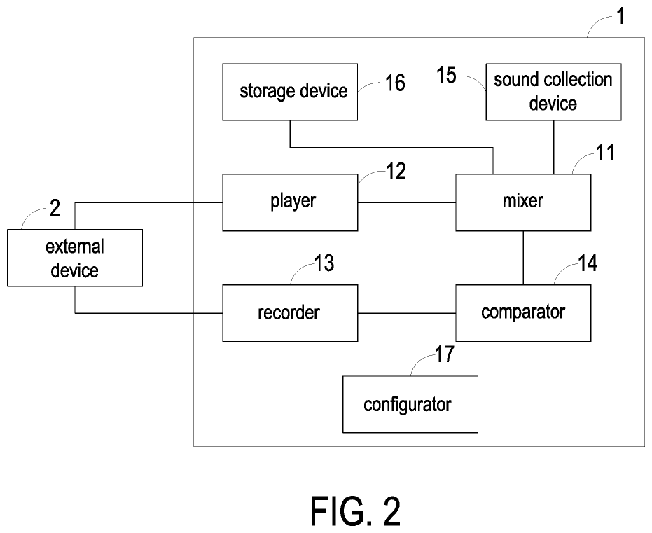

FIG. 1 and FIG. 2 are schematic block diagrams illustrating a system for evaluating noise cancelling capability and an external device according to an embodiment of the present disclosure. As shown in FIGS. 1 and 2, the system for evaluating noise cancelling capability of the present disclosure is configured for evaluating the noise cancelling capability of the external device. The system for evaluating noise cancelling capability 1 includes a mixer 11, a player 12, a recorder 13 and a comparator 14. The mixer 11 receives a target audio file and a noise audio file. The mixer 11 mixes the target audio file and the noise audio file and outputs a mix audio file. The sound of the target audio file is for example but not limited to human sound, music or the sound of specific frequency band. In an embodiment, the mixer 11 mixes the target audio file and the noise audio file with a variable signal-to-noise ratio. The user is allowed to adjust the signal-to-noise ratio through controlling the parameter setting of the mixer 11 according to actual requirements. The player 12 is connected to the mixer 11 and an external device 2 for receiving the mix audio file and outputting a first audio signal to the external device 2. The external device 2 cancels the noise of the first audio signal and outputs a second audio signal. The recorder 13 is connected to the external device 2 for receiving the second audio signal, and the recorder 13 outputs a noise-cancelled audio file. The comparator 14 receives the noise-cancelled audio file and compares the noise-cancelled audio file and the target audio file. According to the comparing result, the comparator 14 outputs an evaluation report.

The evaluation report includes quantified data, which allows the user to objectively understand the noise cancelling capability of the external device. For example, as shown in Table 1, the performance of the noise cancelling capability is quantified according to the PESQ-MOS (Perceptual Evaluation of Speech quality—Mean Opinion Score). The evaluation report includes the MOS numerical value corresponding to the noise cancelling capability of the external device. The MOS numerical value equal to or higher than 3.1 represents the voice quality generally accepted by users. Accordingly, the user is allowed to directly understand the advantages and disadvantages of the noise cancelling capability through the MOS numerical value. Certainly, the evaluation report merely needs to have objective quantified data and allow the user to know the advantages and disadvantages of the noise cancelling capability, and the actual evaluation report is not limited to above embodiment.

TABLE 1

| MOS | the quality of | |
|---|---|---|
| numerical | noise cancelling | |
| value | capability | service condition |
| 5.0 | excellent | clearly hearing the target sound |
| | | with no distortion and no delay |
| 4.0 | good | hearing the target sound with |
| | | low delay and a little noise |
| 3.0 | normal | cannot fully hearing the target |
| | | sound with a certain delay, |
| | | noise and distortion |
| 2.0 | bad | cannot fully hearing the target |
| | | sound with a loud noise or |
| | | breaking signals and serious |
| | | distortion |
| 1.0 | poor | mute or completely unable to |
| | | hear the target sound with |
| | | extremely loud noise |

In an embodiment, the system for noise cancelling capability 1 further includes a sound collection device 15 connected to the mixer 11. The sound collection device 15 is configured for recording the target audio file and/or the noise audio file and transmitting the recorded audio file to the mixer 11. When the current ambient noise is less than 10 dB, the target audio file can be directly recorded by the sound collection device 15. For example but not exclusively, the sound collection device 15 is a microphone.

In an embodiment, the system for evaluating noise cancelling capability 1 further includes a storage device 16 connected to the mixer 11. The storage device 16 stores a plurality of noise audio files and transmits one of the plurality of noise audio files to the mixer 11. The plurality of noise audio files respectively includes the ambient noise in various environments, such as the low-frequency noise from the engine of automobiles or motorcycles and the high-frequency noise from horn. Therefore, the system for evaluating noise cancelling capability 1 can simulate and evaluate the noise cancelling capability of the external device 2 under various environments. Namely, the system for evaluating noise cancelling capability 1 is not limited to evaluate the noise cancelling capability of the external device 2 under the current surrounding of the user only. Accordingly, the user is allowed to fully understand the performance of the external device 2. In an embodiment, the sound collection device 15 may record the ambient noise of various environments in advance and store the recorded noise audio file in the storage device 16.

In an embodiment, the system for evaluating noise cancelling capability 1 further includes a configurator 17. The configurator 17 is configured for setting a default format. The file format of the target audio file, the noise audio file, the mix audio file and the noise-cancelled audio file are all consistent with the default format, so as to ensure the storage format of the audio files in the system are consistent. The default format set by the configurator 17 is for example but not limited to include parameters such as sample rate, bit depth, channel, etc.

In an embodiment, the player 12 and the recorder 13 of the system for evaluating noise cancelling capability 1 communicate with the external device 2 for transmitting audio signals via wired manner. In an embodiment, the player 12 and the recorder 13 of the system for evaluating noise cancelling capability 1 communicate with the external device 2 for transmitting audio signals via wireless manner. The wireless manner is for example but not limited to Bluetooth communications protocol AptX-HD/LDAC, which can transmit voice data losslessly. In fact, the system for evaluating noise cancelling capability 1 of the present disclosure may have connection interfaces for both wired transmission and wireless transmission. The connection way between the system for evaluating noise cancelling capability 1 and the external device 2 depends on the connection interface of the external device 2. In other words, the system for evaluating noise cancelling capability 1 of the present disclosure is applicable for the external device 2 with connection interface for wireless transmission and/or wired transmission.

In an embodiment, the system for evaluating noise cancelling capability 1 connects to a cloud system (not shown). The evaluation report outputted by the comparator 14 of the system for evaluating noise cancelling capability 1 is transmitted to the cloud system. Therefore, the user can browse and compare the evaluation reports of various external devices.

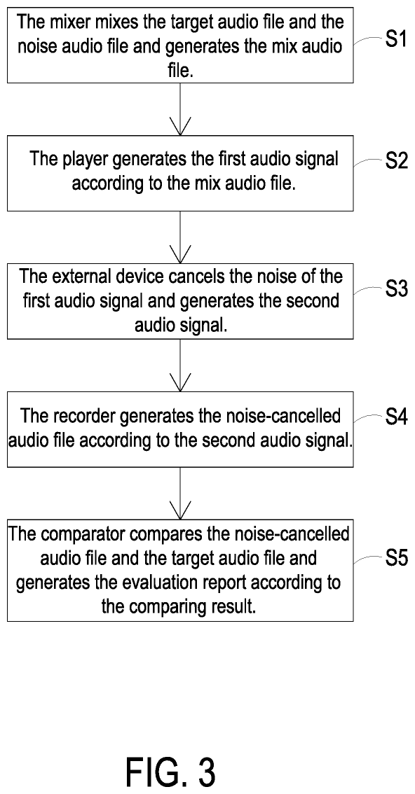

FIG. 3 is a flowchart illustrating a method for evaluating noise cancelling capability according to an embodiment of the present disclosure. The method for evaluating noise cancelling capability of the present disclosure is applicable for the system for evaluating noise cancelling capability 1 of FIGS. 1 and 2. As shown in FIG. 3, the method for evaluating noise cancelling capability includes the following steps.

Firstly, the mixer 11 mixes the target audio file and the noise audio file and generates the mix audio file (step S1). In an embodiment, the mixer 11 mixes the target audio file and the noise audio file with a variable signal-to-noise ratio.

Then, the player 12 generates the first audio signal according to the mix audio file (step S2).

Then, the external device 2 cancels the noise of the first audio signal and generates the second audio signal (step S3).

Afterwards, the recorder 13 generates the noise-cancelled audio file according to the second audio signal (step S4).

Finally, the comparator 14 compares the noise-cancelled audio file and the target audio file and generates the evaluation report according to the comparing result (step S5).

In an embodiment, before step S1, the sound collection device 15 records and transmits the target audio file or/and the noise audio file to the mixer 11. In an embodiment, before step S1, the storage device 16 stores a plurality of noise audio files and provides one of the noise audio files to the mixer 11. In an embodiment, before step S1, the configurator 17 sets the default format, and the file format of the target audio, the noise audio file, the mix audio file and the noise-cancelled audio file are all consistent with the default format.

From the above description, the present disclosure provides a system and a method for evaluating noise cancelling capability. The system and the method for evaluating noise cancelling capability allow the user to conveniently and quickly evaluate the noise cancelling capability of an external device. Further, a quantified evaluation report is provided according to the evaluation result. Accordingly, the user is allowed to understand the performance of the external device objectively and compares the noise cancelling capability of various external devices. In addition, the system and the method are able to simulate and evaluate the noise cancelling capability of an external device under various ambient noises, which is not limited to the noise of the current surrounding of the user. It is helpful for the user to fully understand the performance of the external device.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A system for evaluating noise cancelling capability, the system being configured to evaluate a noise cancelling capability of an external device, the system comprising:
a mixer receiving and mixing a target audio file and a noise audio file and outputting a mix audio file;
a player connected to the mixer for receiving the mix audio file, wherein the player outputs a first audio signal to the external device according to the mix audio file, and the external device cancels the noise of the first audio signal and outputs a second audio signal;
a recorder receiving the second audio signal and outputting a noise-cancelled audio file; and
a comparator connected to the recorder for receiving the noise-cancelled audio file,
wherein the comparator compares the noise-cancelled audio file and the target audio file and outputs an evaluation report according to a comparing result.

2. The system according to claim 1, further comprising a sound collection device connected to the mixer, wherein the sound collection device is configured for recording the target audio file or/and the noise audio file and transmitting the recorded audio file to the mixer.

3. The system according to claim 1, further comprising a storage device connected to the mixer, wherein the storage device stores a plurality of the noise audio files and transmits one of the plurality of the noise audio files to the mixer.

4. The system according to claim 1, wherein the mixer mixes the target audio file and the noise audio file with a variable signal-to-noise ratio.

5. The system according to claim 1, further comprising a configurator, wherein the configurator is configured for setting a default format, and a file format of the target audio file, the noise audio file, the mix audio file and the noise-cancelled audio file are all consistent with the default format.

6. The system according to claim 1, wherein the player and the recorder communicate with the external device for transmitting the audio files via wired or wireless manner.

7. A method for evaluating noise cancelling capability, the method being configured to evaluate a noise cancelling capability of an external device, the method comprising:
(a) mixing a target audio file and a noise audio file and generating a mix audio file by a mixer;
(b) generating a first audio signal according to the mix audio file by a player;
(c) cancelling the noise of the first audio signal and generating a second audio signal by the external device;
(d) generating a noise-cancelled audio file according to the second audio signal by a recorder; and
(e) comparing the noise-cancelled audio file and the target audio file and generating an evaluation report according to a comparing result by a comparator.

8. The method according to claim 7, further comprising a step of recording and transmitting the target audio file or/and the noise audio file to the mixer by a sound collection device.

9. The method according to claim 7, further comprising a step of storing a plurality of the noise audio files and providing one of the plurality of the noise audio files to the mixer by a storage device.

10. The method according to claim 7, wherein in the step (a), the mixer mixes the target audio file and the noise audio file with a variable signal-to-noise ratio.

11. The method according to claim 7, further comprising a step of setting a default format by a configurator, wherein a file format of the target audio file, the noise audio file, the mix audio file and the noise-cancelled audio file are all consistent with the default format.

12. The method according to claim 7, wherein the player and the recorder communicate with the external device for transmitting the audio files via wired or wireless manner.
